(19) United States
(12) Patent Application Publication
(10) Pub. No.: US 2018/0114307 A1
(43) Pub. Date: Apr. 26, 2018

(54) SYSTEM AND METHOD FOR DETECTING ANOMALIES IN A COMPONENT

(71) Applicant: General Electric Company, Schenectady, NY (US)

(72) Inventors: Nathaniel Benedict Hawes, Ballston Spa, NY (US); Michael Colan Moscinski, Glenville, NY (US); Sara Saxton Underwood, Niskayuna, NY (US); Jonas Patrik Richard Gustavsson, Fort Walton Beach, FL (US)

(21) Appl. No.: 15/334,413

(22) Filed: Oct. 26, 2016

(51) Int. Cl. G06T 7/00; G01J 5/00; H04N 5/33

(52) U.S. Cl. CPC G06T 7/0004; G01J 5/0088; H04N 5/33; G06T 2207/30164; G01J 2005/0085; G06T 2207/10016; G06T 2207/10048; G01J 2005/0077

(57) ABSTRACT

An inspection system for inspecting a component is presented. The inspection system includes a probe unit, wherein the probe unit includes a first flux concentrator operatively coupled to a first surface of the component. Also, the probe unit includes at least one inductive coil positioned around the first flux concentrator, and configured to induce an electrical current flow in at least a portion of the component via the first flux concentrator. Further, the inspection system includes an infrared (IR) camera configured to capture a plurality of frames corresponding to the portion of the component. In addition, the inspection system includes a processing unit electrically coupled to the IR camera and configured to determine an anomaly in the component based on the captured plurality of frames.

### BACKGROUND

Embodiments of the present specification relate generally to inspection of a component and more particularly to a system and method for detecting anomalies in the component.

Increasingly, components of gas turbines are constructed from ceramic matrix composites (CMCs) to achieve favorable mechanical properties, such as strength and ductility, at elevated temperatures. Some components of gas turbines include combustor liners, shrouds, nozzles, vanes, buckets, and blades. Manufacturing processes for CMC components are currently not as mature as the manufacturing processes for metal components. Consequently, the CMC components may develop one or more anomalies during manufacturing of the components. Also, during operation of the gas turbines, the components may be subjected to stress or centrifugal force, which may cause cracks or other anomalies in these components. In some components, these cracks may occur below an environmental barrier coating (EBC) and hence, the cracks may not be visible to a user/inspector. However, though not visible, these cracks on these components may lead to a structural malfunction of the gas turbines and may substantially damage the gas turbines. Thus, there is a need to detect the anomalies in the components of the gas turbines and/or the combustors.

Conventionally, the components are visually inspected or inspected using a technique such as fluorescent penetrant inspection (FPI), thermography, ultrasound, or CT scanning to detect the cracks. For visual inspection, if the cracks are underneath the EBC, it may be difficult for an operator to visually identify the cracks without removing the coating from the components. Also, many of the alternative inspection techniques require that the EBC be removed from the components before inspection. Further, after inspection, the EBC needs to be recoated prior to putting the components back in service. Removing the coating and recoating the components may substantially increase the cost associated with inspection of these components. Moreover, visual inspection and the FPI, thermography, ultrasound, and CT scanning methods require a trained operator to inspect the components and make a decision to scrap the components or send the components for repair.

### BRIEF DESCRIPTION

In accordance with aspects of the present specification, an inspection system for inspecting a component is presented. The inspection system includes a probe unit, wherein the probe unit includes a first flux concentrator operatively coupled to a first surface of the component. Also, the probe unit includes at least one inductive coil positioned around the first flux concentrator, and configured to induce an electrical current flow in at least a portion of the component via the first flux concentrator. Further, the inspection system includes an infrared (IR) camera configured to capture a plurality of frames corresponding to the portion of the component. In addition, the inspection system includes a processing unit electrically coupled to the IR camera and configured to determine an anomaly in the component based on the captured plurality of frames.

In accordance with another embodiment of the present specification, a method for inspecting a component is presented. The method includes inducing, by at least one inductive coil, an electrical current flow in at least a portion of the component via a first flux concentrator. Also, the method includes capturing, by an infrared (IR) camera, a plurality of frames corresponding to the portion of the component. Further, the method includes constructing, by a processing unit, a thermal image based on the plurality of frames corresponding to the portion of the component. In addition, the method includes determining presence of a thermal signature in the thermal image, wherein the thermal signature is representative of an anomaly in the component.

### DRAWINGS

These and other features, aspects, and advantages of the present disclosure will become better understood when the following detailed description is read with reference to the accompanying drawings in which like characters represent like parts throughout the drawings, wherein:

FIG. 1 illustrates a diagrammatical representation of a system for inspecting a component, in accordance with aspects of the present specification;

FIG. 2 is diagrammatical representation of a system for inspecting a component, in accordance with another embodiment of the present specification;

FIG. 3 is an elevation view of an inductive coil and a first flux concentrator in a probe unit, in accordance with one embodiment of the present specification;

FIG. 4 is an elevation view of inductive coils and the first flux concentrator in the probe unit, in accordance with another embodiment of the present specification;

FIG. 5 is an elevation view of inductive coils and the first flux concentrator in the probe unit, in accordance with yet another embodiment of the present specification;

FIGS. 6 and 7 are elevation views of first flux concentrators having different shapes, in accordance with embodiments of the present specification;

FIGS. 8-12 are cross sectional views of a first flux concentrator having different cross sections, in accordance with aspects of the present specification;

FIG. 13 is an elevation view of a first flux concentrator having a rod shape with a contoured probe tip, in accordance with aspects of the present specification;

FIGS. 14 and 15 are top views of inductive coils and a first flux inductor, in accordance with one embodiment of the present specification;

FIG. 16 is an elevation view of an inductive coil wound over a first flux concentrator, in accordance with another embodiment of the present specification;

FIG. 17 illustrates different cross-sectional views of inductive coils, in accordance with one embodiment of the present specification; and

FIG. 18 is a flow chart illustrating a method for detecting anomalies in a component, in accordance with aspects of the present specification.

### DETAILED DESCRIPTION

As will be described in detail hereinafter, various embodiments of a system and method for inspecting a component for detecting presence or absence of anomalies are presented. In particular, the system and method presented herein detect one or more anomalies in the component without destructing the component. Also, the system and method presented herein may detect the anomalies or cracks of any orientation on the component. Moreover, the system and method presented herein detect one or more anomalies in the component even if the anomalies are underneath an environmental barrier coating (EBC) of the component.

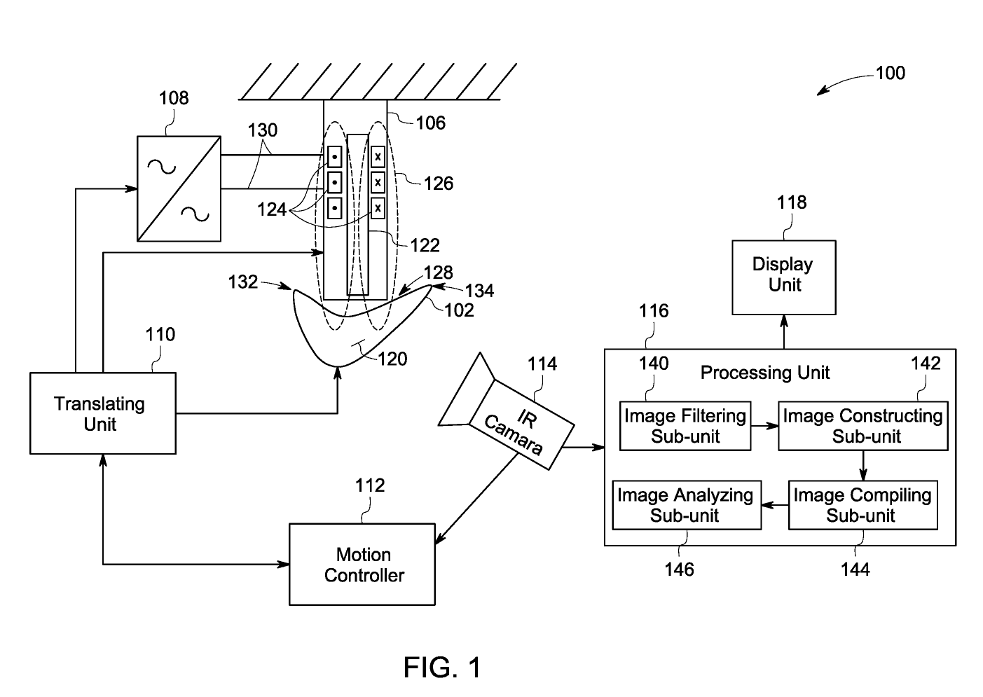

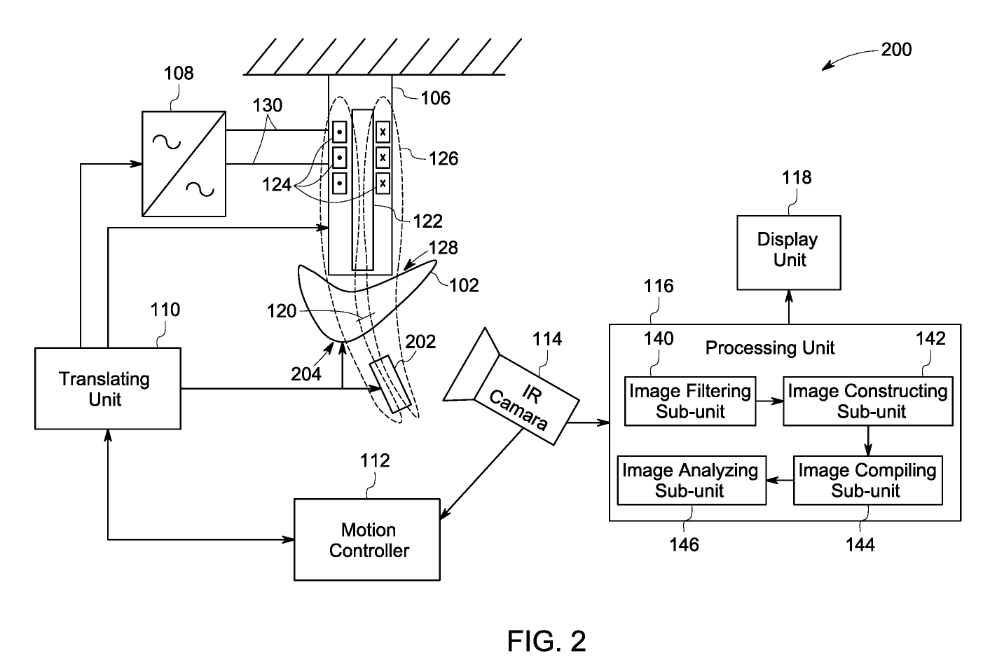

FIG. 1 illustrates a diagrammatical representation of a system 100 for inspecting one or more components 102, in accordance with aspects of the present specification. The components 102 may be components that are disposed in gas turbines. In one example, the components 102 of the gas turbines may include combustor liners, shrouds, nozzles, vanes, buckets, and blades. It may be noted that the components 102 may be any machinery components, and are not limited to the components used in the gas turbines. The description of components 102 in FIGS. 1-2 is with respect to high pressure turbine (HPT) blades having a coating used in gas turbines, however, other such components 102 are also envisioned within the purview of this application. In one example, the coating over the blades may be environmental barrier coating (EBC), thermal barrier coating (TBC), and/or any other similar coating.

In a presently contemplated configuration, the system 100 includes a probe unit 106, a power unit 108, a translating unit 110, a motion controller 112, an infrared (IR) camera 114, a processing unit 116, and a display unit 118. In operation, the component 102 that needs to be inspected is operatively coupled to the translating unit 110. In one example, the component 102 may be operatively coupled to a base unit (not shown in FIG. 1) that is configured to keep the component 102 stationary while inspecting the component 102.

Further, the probe unit 106 is used to thermally scan the component 102 to detect anomalies, such as cracks, porosity, voids, material inconsistencies, and/or material impurities in the component 102. In one embodiment, the anomalies may be originated from initial manufacturing of the component, fatigue, and/or other causes. In the illustrated example, the anomalies in the component 102 are referred to as cracks, however, other kinds of abnormalities or defects may be detected by employing the systems and methods of the present application. It may be noted that a crack 120 may be defined as an air gap on the surface of the component 102 or within the component 102. Also, the crack 120 may be of any orientation on the surface of the component 102. In one embodiment, the probe unit 106 is operatively coupled to the translating unit 110 to move or translate the probe unit 106 across the component 102 in one or more directions and/or angles with respect to the component 102. In one example, the probe unit 106 may be a portable device. The portable device may have a length in a range from about 0.25 inch to about 60 inches and a width in a range from about 0.25 inch to about 60 inches.

Further, the probe unit 106 includes a first flux concentrator 122 and one or more inductive coils 124. As depicted in FIG. 1, the one or more inductive coils 124 are positioned around the first flux concentrator 122 and configured to generate a magnetic field 126 around the inductive coils 124. Moreover, the first flux concentrator 122 is used to direct the generated magnetic field 126 towards the component 102. In one example, the first flux concentrator 122 may include ferromagnetic material that aids in directing or redirecting the generated magnetic field 126 towards the component 102. Also, the ferromagnetic material may have a relative magnetic permeability greater than 1 that aids in directing the magnetic field 126 in a desired direction. In one embodiment, the first flux concentrator 122 may include materials such as, powdered iron composites, nickel alloys, cobalt alloys, and/or ferrites. Further, the first flux concentrator 122 may be positioned on or proximate to a first surface 128 of the component 102. It may be noted that the first flux concentrator 122 may be of any shape so that the shape of the first flux concentrator 122 corresponds to a shape of at least a portion of the component 102. It may be noted that different shapes of the first flux concentrator 122 will be explained in greater detail with respect to FIGS. 6-13. It should also be noted that the first flux concentrator 122 may be divided into a plurality of flux concentrators each interfacing with at least a portion of the component 102.

Further, the power unit 108 is electrically coupled to the inductive coil 124 via power transmission cables 130 to energize or excite the inductive coil 124. In one example, the power unit 108 may include a high frequency power converter that supplies a power in a range from about 10 W to 100 kW having a frequency in a range from about 10 kHz to about 3 MHz to energize the inductive coil 124. Further, the energized inductive coil 124 may generate the magnetic field 126 that is directed towards the component 102 via the first flux concentrator 122 to induce an electrical current flow into the component 102. In one example, the electrical current may be in a range from about 10 A to about 2000 A. This induced electrical current flow in the component 102 may cause heat distribution across the component 102. However, if the component 102 includes one or more cracks 120, the heat distribution may be altered in the component 102. Particularly, the electrical current flow induced in the component 102 is obstructed by the crack 120 causing direct heating of the component 102 resulting in a heating pattern at a location of the crack 120. More specifically, the cracks 120 in the component 102 may obstruct the corresponding current flow causing direct heating of the component 102 resulting in a heating pattern at a location of each of the cracks 120.

Furthermore, the translating unit 110 and the motion controller 112 may be operatively coupled to the probe unit 106 and configured to provide a translation motion to the probe unit 106 with respect to the first surface 128 of the component 102. Particularly, the component 102 may be kept stationary while inspecting the component 102. Further, the translating unit 110 may be controlled by the motion controller 112 to translate or move the probe unit 106 at a constant speed or in block-wise motion from a first end 130 of the component 102 to a second end 134 of the component 102, and vice-versa. As a result, the electrical current may be induced at multiple locations across the component 102. Also, it may be noted that the translating unit 110 may move the probe unit 106 in one or more directions and/or one or more angles to induce the electrical current in multiple directions into the component 102. By inducing electrical current in multiple directions into the component 102, cracks 120 that are in different orientations in the component 102 may be detected.

In one embodiment, the translating unit 110 and the motion controller 112 may be operatively coupled to the component 102 and configured to provide a translation motion to the component 102 with respect to the probe unit 106.

Particularly, the probe unit 106 may be kept stationary while inspecting the component 102. Further, the translating unit 110 may be controlled by the motion controller 112 to translate or move the component 102 at a constant speed or in block-wise motion across the probe unit 106. It may be noted that the translating unit 110 may move the component 102 in one or more directions and/or one or more angles with respect to the probe unit 106.

As depicted in FIG. 1, the IR camera 114 may be positioned at a predetermined distance from the component 102 to capture thermographic data of the component 102. Particularly, the electrical current that is induced by the probe unit 106 into the component 102 may generate and distribute heat across the component 102. This heat distribution in the component 102 is captured by the IR camera 114 as temperature profiles or thermographic data. In one example, the thermographic data may include a plurality of thermal image frames, also referred to hereinafter as a “plurality of frames,” captured at different time intervals when the probe unit 106 is translated to different locations on the component 102. The component 102 may be within a field of view of the IR camera 114. In one example, the IR camera 114 may capture the thermographic data at a speed of 1 to 200 frames per second. Also, the IR camera 114 may operate in either mid-wave or long-wave range of infrared spectrum. In one embodiment, the scanning speed and heating time of the inductive coil 124 are adjusted based on the IR camera frame rate, which is typically between 1 Hz and 200 Hz. In one embodiment, multiple IR cameras may be positioned in different angles and/or directions to capture the thermographic data at a corresponding angle and/or direction with respect to the component 102. In one embodiment, coil current or electrical current in the inductive coil 124 is alternatingly turned ON and OFF and the transient response of the component 102 is recorded by capturing several frames using one or more IR cameras. An alternative method for transient heating is moving the inductive coil 124 relative to the surface rapidly compared to the camera frame rate.

Further, the processing unit 116 is electrically coupled to the IR camera 114 to process the thermographic data of the component 102 to detect one or more cracks 120 in the component 102. In one example, the processing unit 116 may process the plurality of frames captured at different time intervals to create one or more images of the component 102. In one embodiment, the processing unit 116 may include one or more image filtering sub-units 140 that are used to reduce or mitigate noise and/or unwanted signals from the captured frames. Also, the processing unit 116 may include an image constructing sub-unit 142 coupled to the image filtering sub-units 140 to create one of more images of the component 102 from the filtered frames. Further, the processing unit 116 may compile and align these images to construct a high-resolution thermal image of the component 102. In one embodiment, the processing unit 116 may include an image compiling sub-unit 144 coupled to the image constructing sub-unit 142 to construct the high-resolution thermal image from the one or more created images. Also, the processing unit 116 may identify one or more thermal signatures in the constructed thermal image that are representative of the cracks 120 in the component 102. It may be noted that a thermal signature may include a heating pattern or temperature profiles on the surface of the component 102. In one embodiment, the processing unit 116 may use one or more specialized algorithms to identify the thermal signatures in the constructed thermal image. Also, in one embodiment, the processing unit 116 may extract local thermal gradients using finite differences between adjacent pixels, for example in the form of Sobel edge detection or Laplacian kernels to identify the thermal signatures in the constructed thermal image. In another embodiment, the processing unit 116 may include a database that is created by analysis of known anomalies and/or other surface features in the component 102. Further, the processing unit 116 may include an image analyzing sub-unit 146 that may use image analysis techniques, such as spatial and spectral filtering techniques along with thermal signature identification data from the database to identify the thermal signatures in the constructed thermal image. It may be noted that the processing unit 116 may have other components, and is not limited to the components/sub-units shown above. Also, in one embodiment, the processing unit 116 may use pre-stored instructions or pre-stored algorithms for each of the sub-units in the processing unit 116 for performing a corresponding function of the sub-units. Further, the processing unit 116 may display the constructed thermal image on the display unit 118 to enable the user/operator to view the thermal signatures representative of one or more cracks 102 in the component 102.

Advantageously, the systems and methods of the present application are configured to detect one or more cracks 120 of same or different orientations on a surface of the component 102 even when the surface of the component 102 is covered during detection or inspection. By way of example, the surface of the component 102 may be covered with a coating, a layer or foreign particles (e.g., dust, grease, chemical species, and the like). Further, the cracks 120 may be completely or partly disposed underneath the coating or the layer. In the illustrated example of FIGS. 1-2, the cracks 120 may be automatically detected by the system 100 without removing the EBC or any other coating from the component 102. Also, the cracks 120 may be detected even if the component 102 is covered with a few nanometers/centimeters of dirt or other non-electrical layers.

Referring to FIG. 2, a diagrammatical representation of a system 200 for inspecting one or more components 102, in accordance with one embodiment of the present specification, is depicted. The system 200 is similar to the system 100 of FIG. 1. Further, in addition to the components of FIG. 1, the system 200 includes a second flux concentrator 202. Particularly, the first flux concentrator 122 in the probe unit 106 may be disposed on or proximate the first surface 128 of the component 102 to direct the generated magnetic field 126 towards the component 102. Further, the second flux concentrator 202 is operatively coupled to a second surface 204 of the component 102. The second surface 204 of the component 102 may be opposite to the first surface 128 of the component. The second flux concentrator 202 is configured to steer the generated magnetic field 126 towards a determined location in the component 102.

During operation, the probe unit 106 and the component 102 may be kept stationary while inspecting the component 102. The first flux concentrator 122 in the probe unit 106 may direct the magnetic field 126 generated by the inductive coil 124 to a location on the component 102. Further, the translating unit 110 may be controlled by the motion controller 112 to translate or move the second flux concentrator 202 at a constant speed or in block-wise motion in a desired direction to steer the magnetic field 126 to multiple locations on the component. As the magnetic field is moved to multiple locations on the component 102, the electrical current is also induced at multiple locations on the component 102. As a result, cracks 120 that are at different locations in the component 102 may be detected without moving the probe unit 106 or the component 102.

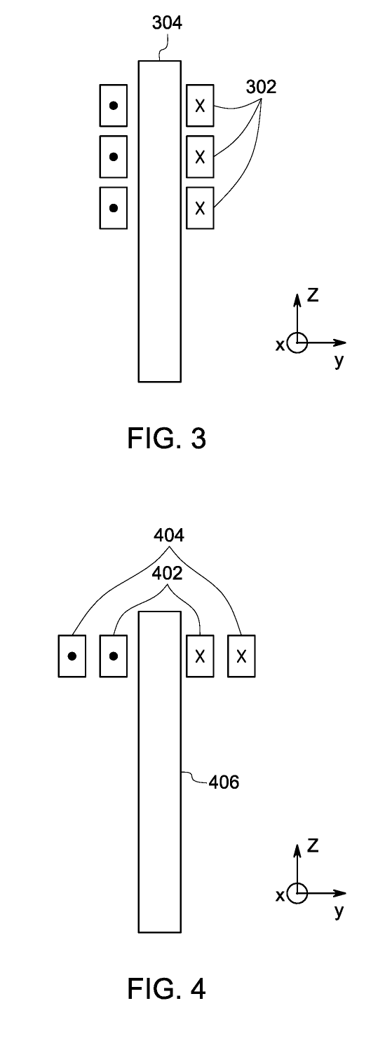

Referring to FIG. 3, an elevation view of an inductive coil and a first flux concentrator in a probe unit, in accordance with one embodiment of the present specification, is depicted. The inductive coil 302 is similar to the inductive coil 124 of FIG. 1. Also, the first flux concentrator 304 is similar to the first flux concentrator 122 of FIG. 1. The inductive coil 302 is spirally wound around the first flux concentrator 304 to generate the magnetic field that is directed towards the component via the first flux concentrator 304. In one example, the inductive coil 302 may be referred to as a solenoid induction coil. The inductive coil 302 is spirally wound to provide additional magnetic field for a given amount of current input into the coil. In one embodiment, a plurality of inductive coils may be coupled to each other in series and these inductive coils may be spirally wound around the first flux concentrator 304. In one example, the first flux concentrator 304 may be an elongated member having a rod or rectangular shape that aids in guiding the generated magnetic field towards the component 102. It may be noted the first flux concentrator 304 may be of any structure and/or shape, and is not limited to the structure and shape shown in FIG. 3.

Referring to FIG. 4, an elevation view of inductive coils and a first flux concentrator in a probe unit, in accordance with another embodiment of the present specification, is depicted. In this embodiment, the probe unit 106 includes a first inductive coil 402 and a second inductive coil 404 that are concentrically positioned with each other and are coupled in series with each other. Also, as depicted in FIG. 4, the first inductive coil 402 and the second inductive coil 404 are positioned around the first flux concentrator 406 to provide a more uniform magnetic field profile, which will lead to a more uniform temperature profile incident upon the component 102. In another embodiment, a single contiguous coil may be spirally wound in-plane around the first flux concentrator 406 to have a concentric arrangement of the coil.

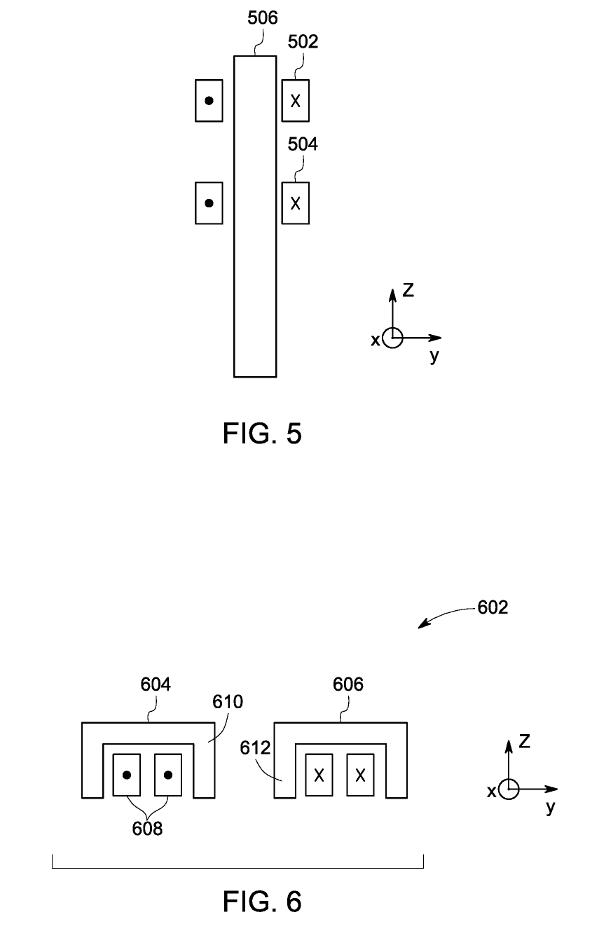

Referring to FIG. 5, an elevation view of inductive coils and a first flux concentrator in a probe unit, in accordance with yet another embodiment of the present specification, is depicted. In this embodiment, the probe unit 106 includes a first inductive coil 502 and a second inductive coil 504 that are spaced apart and are positioned around the first flux concentrator 506. The first inductive coil 502 and the second inductive coil 504 are excited different frequencies to test or inspect the component 102. For example, the first inductive coil 502 is configured to induce an electrical current having a first frequency, while the second inductive coil 504 is configured to induce an electrical current having a second frequency. Particularly, the power unit 108 may supply a power having a first frequency to the first inductive coil 502 to induce the electrical current having the first frequency. In one example, the first frequency may be referred to as a high frequency that is in a range from about 100 kHz to about 3 MHz. Concurrently, the power unit 108 may supply a power having a second frequency to the second inductive coil 504 to induce the electrical current having the second frequency. In one example, the second frequency may be referred to as a low frequency that is in a range from about 10 kHz to about 400 kHz. Further, the electrical current having the first frequency or high frequency may be used to detect the cracks 120 at the edges of the component 102. More specifically, the electrical current having the first frequency or high frequency may flow through the edges of the component 102. If the cracks are present in the edges of the component, this electrical current flow is obstructed by the cracks 120 causing direct heating of the component 102 resulting in a heating pattern at a location of the crack 120. This heating pattern may be used to identify the cracks 120 in the component 102. In a similar manner, the inductive coil having the second frequency or low frequency may be used to detect the cracks 120 other than at the edges of the component 102.

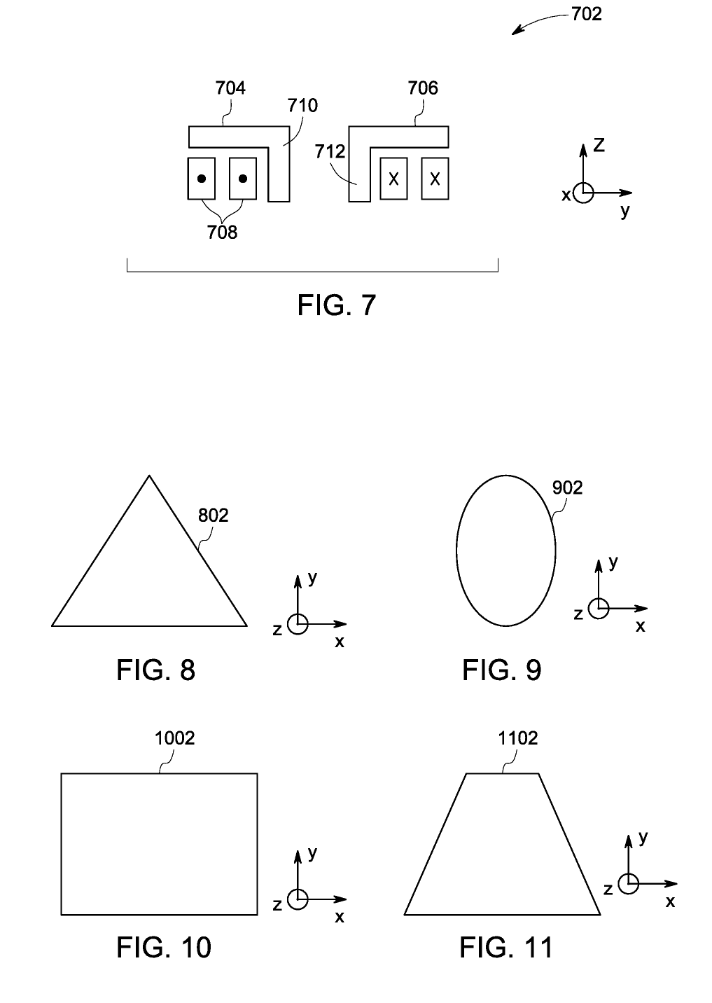

FIGS. 6 and 7 illustrate an elevation view of the first flux concentrator having different shapes, in accordance with one embodiment of the present specification. FIG. 6 depicts the first flux concentrator 602 having a first segment 604 and a second segment 606 that are in U-shape. In this embodiment, one or more inductive coils 608 are positioned around a leg of each of the first and second segments 604, 606. For example, one leg 610 of the first segment 604 is positioned adjacent to a corresponding leg 612 of the second segment 606. Further, the inductive coils 608 are wound around the legs 610, 612 of the first and second segments 604, 606, as depicted in FIG. 6. In a similar manner, FIG. 7 depicts the first flux concentrator 702 having a first segment 704 and a second segment 706 that are in L-shape. In this embodiment, legs 710, 712 of the first and second segments 704, 706 are positioned adjacent to each other. Further, the inductive coils 708 are positioned around the legs 710, 712 of the first and second segments 704, 706, as depicted in FIG. 7. In one embodiment, a plurality of flux concentrators may be arranged in U-shape or L-shape within the probe device.

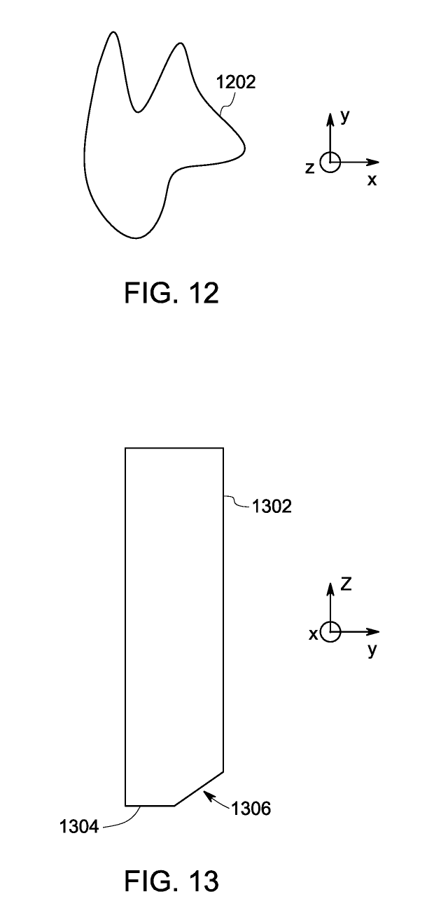

Referring to FIGS. 8-12, a cross sectional view of the first flux concentrator, in accordance with aspects of the present specification, is depicted. Particularly, FIG. 8 depicts a triangular shape 802 of the first flux concentrator. FIG. 9 depicts a circular shape 902 of the first flux concentrator. FIG. 10 depicts a square shape 1002 of the first flux concentrator. FIG. 11 depicts a trapezoidal shape 1102 of the first flux concentrator. FIG. 12 depicts an irregular shape 1202 of the first flux concentrator. In one embodiment, the second flux concentrator may also include different shapes similar to the shapes of the first flux concentrator.

FIG. 13 is an elevation view of the first flux concentrator 1302 having a rod shape, in accordance with aspects of the present specification. Particularly, the first flux concentrator 1302 is an elongated member having the rod shape that aid in directing the magnetic field towards the component 102. In addition, the elongate member has a contoured tip 1304 at an end 1306 facing the component 102 to conform the magnetic field to a desired location on the component 102. It may be noted that the elongate member of the first flux concentrator 1302 may have a variable geometry for better conformation of the magnetic field on the component 102. In one embodiment, the tip of the first flux concentrator 1302 may be altered to change the distribution of the induced electrical current within the component 102.

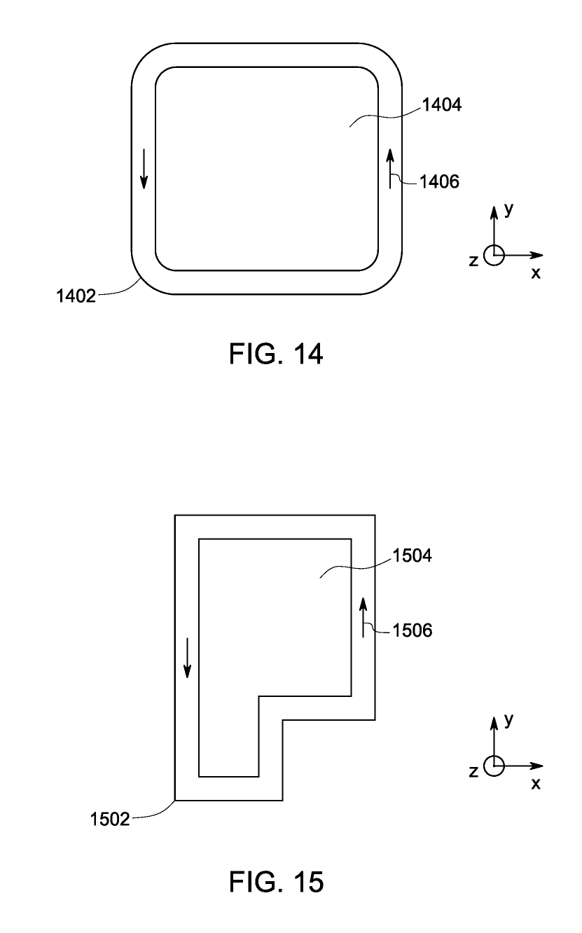

Referring to FIGS. 14 and 15, top view of the inductive coils and the first flux inductor, in accordance with one embodiment of the present specification, is depicted. Particularly, FIG. 14 shows the inductive coil 1402 positioned around the first flux inductor 1404 having a square shape. Also, electrical current flow direction 1406 in the inductive coil 1402 is depicted in FIG. 14. In a similar manner, FIG. 15 shows the inductive coil 1502 positioned around the first flux inductor 1504 having a ‘P’ shape. Also, electrical current flow direction 1506 in the inductive coil 1502 is depicted in FIG. 15. In the embodiments of FIGS. 14 and 15, the shape of the inductive coil 1502 may aid in altering the magnetic field and temperature profiles imparted on the component 102.

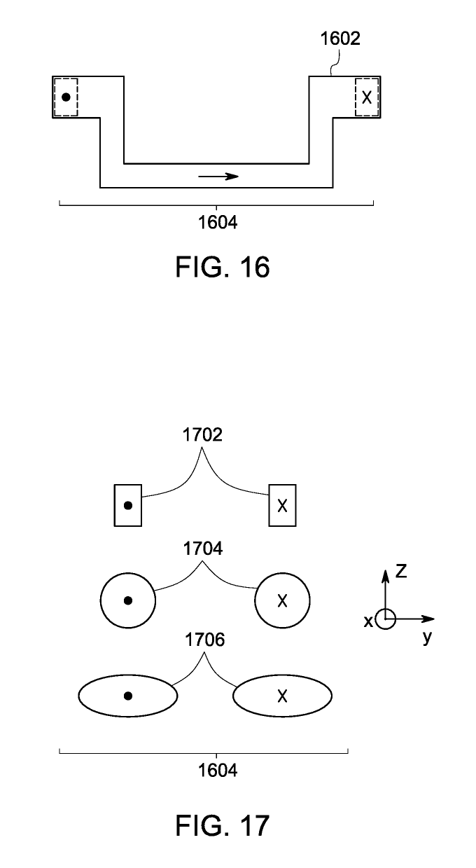

Referring to FIG. 16, an elevation view of the inductive coil 1602 wound over the first flux concentrator, in accordance with another embodiment of the present specification, is depicted. Particularly, a portion 1604 of the inductive coil 1602 is curved or bent to form an ‘U’ shape while surrounding the first flux concentrator, as depicted in FIG. 16. This configuration may be used to follow contours of the component or impart increased localized heating in a section of the component 102.

FIG. 17 illustrates different cross-sectional views of the inductive coils, in accordance with one or more embodiments of the present specification. Particularly, reference numeral 1702 represents a square shape of the inductive coil. Reference numeral 1704 represents a circular shape of the inductive coil. Similarly, reference numeral 1706 represents an oval shape of the inductive coil. It may be noted that the inductive coils may have any shape, and is not limited to the shapes shown in FIG. 17.

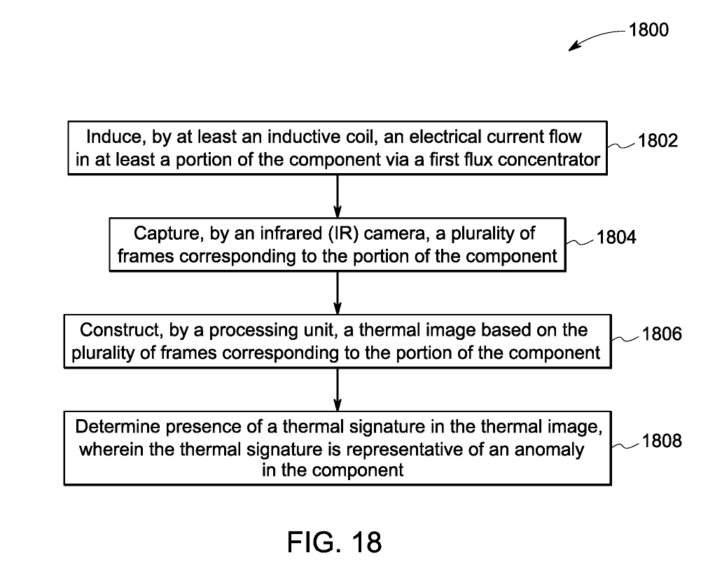

Referring to FIG. 18, a flow chart illustrating a method 1800 for detecting anomalies in a component, in accordance with aspects of the present specification, is depicted. The method 1800 is described with reference to the components of FIGS. 1-2. The method 1800 begins at block 1802, where an electrical current flow is induced into the component 102. To that end, a probe unit 106 including an inductive coil 124 and a first flux concentrator 122 is positioned proximate to the component 102. Further, the translating unit 110 in conjunction with the motion controller 112 translate the probe unit 106 from the first end 132 of the component 102 to the second end 134 of the component 102. Also, while translating the probe unit 106, the power unit 108 may energize or excite the inductive coil 124 to generate the magnetic field around the inductive coil 124. Further, the first flux concentrator 122 may direct the generated magnetic field towards the component 102 to induce the electrical current flow in at least a portion of the component 102. This induced electrical current flow may generate heat across the component 102, the generated heat may be distributed across a surface of the component 102.

Subsequently, at block 1804, a plurality of frames corresponding to the portion of the component 102 may be captured at different time intervals. Particularly, when the probe unit 106 is translated across the component 102, the IR camera 114 may capture the frames that represent temperature profiles or thermographic data of the component 102.

Furthermore, at block 1806, a thermal image is constructed based on the plurality of frames corresponding to the portion of the component 102. In one example, the processing unit 116 may use one or more image processing algorithms to process the frames to construct the thermal image of the component 102.

Additionally, at block 1808, the processing unit 116 may determine presence of a thermal signature in the constructed thermal image. The thermal signature is representative of an anomaly in the component 102. In one example, the thermal signature may indicate heating patterns that are associated with one or more cracks in the component 102.

Thus, by employing the exemplary method, cracks 120 of any orientation may be detected in the component. Also, the method may detect the cracks even if the cracks are underneath the coating or any other non-electrical layers on the component 102.

The various embodiments of the exemplary system and method aid in automatically detecting one or more cracks in the component. Also, the cracks in the component are detected without removing the coating, dirt, and/or other non-electrical layers on the component. This in turn reduces the inspection cost and maintenance cost of the component.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. An inspection system for inspecting a component, the inspection system comprising:
a probe unit, wherein the probe unit comprises:
a first flux concentrator operatively coupled to a first surface of the component;
at least one inductive coil positioned around the first flux concentrator, and configured to induce an electrical current flow in at least a portion of the component via the first flux concentrator;
an infrared (IR) camera configured to capture a plurality of frames corresponding to the portion of the component; and
a processing unit electrically coupled to the IR camera and configured to determine an anomaly in the component based on the captured plurality of frames.

2. The inspection system of claim 1, wherein the processing unit is configured to:
construct a thermal image based on the captured plurality of frames; and
determine presence of a thermal signature in the thermal image, wherein the thermal signature is representative of the anomaly in the component.

3. The inspection system of claim 1, wherein the first flux concentrator is disposed on or proximate to the first surface of the component.

4. The inspection system of claim 1, further comprising a power unit operatively coupled to the probe unit and configured to excite the inductive coil to generate a magnetic field around the inductive coil.

5. The inspection system of claim 4, wherein the first flux concentrator is configured to direct the generated magnetic field towards the component so as to induce the electrical current flow into the component.

6. The inspection system of claim 5, further comprising a second flux concentrator operatively coupled to a second surface of the component and configured to steer the generated magnetic field towards a determined location in the component.

7. The inspection system of claim 6, wherein the second surface of the component is opposite to the first surface of the component.

8. The inspection system of claim 7, further comprising a translating unit operatively coupled to the probe unit, the component, or both.

9. The inspection system of claim 8, wherein the translating unit is operatively coupled to the probe unit and configured to provide a translation motion to the probe unit with respect to the first surface of the component.

10. The inspection system of claim 8, wherein the translating unit is operatively coupled to the component and configured to provide a translation motion to the component with respect to the probe unit.

11. The inspection system of claim 8, wherein the translating unit is operatively coupled to the second flux concentrator and configured to provide a translation motion to the second flux concentrator with respect to the component.

12. The inspection system of claim 1, wherein the at least one inductive coil is spirally wound around at least a portion of the first flux concentrator.

13. The inspection system of claim 1, comprising a first inductive coil and a second inductive coil that are positioned around the first flux concentrator.

14. The inspection system of claim 13, wherein the first inductive coil and the second inductive coil are coupled in series and concentrically positioned with each other.

15. The inspection system of claim 13, wherein the first inductive coil is configured to induce an electrical current having a first frequency, and wherein the second inductive coil is configured to induce an electrical current having a second frequency.

16. The inspection system of claim 1, wherein the first flux concentrator comprises one or more segments, wherein each of the segment comprises a rod shape, an L-shape, a U-shape, or combinations thereof.

17. The inspection system of claim 1, wherein a cross-section of the first flux concentrator comprise a circular shape, an irregular shape, a square shape, a rectangular shape, a triangular shape, an oval shape, or combinations thereof.

18. The inspection system of claim 1, wherein a shape of the first flux concentrator is modified corresponding to a shape of the component.

19. The inspection system of claim 18, wherein a shape of the at least one inductive coil is modified corresponding to the shape of the first flux concentrator to alter the magnetic field generated by the at least one inductive coil.

20. A method for inspecting a component, the method comprising:
inducing, by at least one inductive coil, an electrical current flow in at least a portion of the component via a first flux concentrator;
capturing, by an infrared (IR) camera, a plurality of frames corresponding to the portion of the component;
constructing, by a processing unit, a thermal image based on the plurality of frames corresponding to the portion of the component; and
determining presence of a thermal signature in the thermal image, wherein the thermal signature is representative of an anomaly in the component.

21. The method of claim 20, further comprising:
exciting, by a power unit, the inductive coil to generate a magnetic field; and
directing, by the first flux concentrator, generated magnetic field towards the component so as to induce the electrical current flow into the component.

22. The method of claim 21, further comprising steering, by a second flux concentrator, the generated magnetic field towards a determined location in the component to induce the electrical current flow at the determined location in the component.

23. The method of claim 22, further comprising providing, by a translating unit, a translation motion to the probe unit with respect to the first surface of the component.

24. The method of claim 23, further comprising providing, by the translating unit, a translation motion to the component with respect to the probe unit.

25. The method of claim 24, further comprising providing, by the translating unit, a translation motion to the second flux concentrator with respect to the component.
